(19) United States
(12) Patent Application Publication
(10) Pub. No.: US 2007/0083853 A1
(43) Pub. Date: Apr. 12, 2007

(54) System and method for declarative validation rule editor

(75) Inventors: Thomas A. Cook, Boulder, CO (US); Troy Beecroft, Boulder, CO (US); Thomas Carl Stamm, Louisville, CO (US); James Barnett, Boulder, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/527,884

(22) Filed: Sep. 27, 2006

Related U.S. Application Data
(60) Provisional application No. 60/721,148, filed on Sep. 27, 2005.

(51) Int. Cl. G06F 9/44; G06F 3/00

(52) U.S. Cl. 717/120; 717/113; 715/764

(57) ABSTRACT

The present invention enables a three-pane page flow editor optimized for viewing and editing a page flow. It provides a visual representation of nodes and the connections among them, enabling the ability to read and edit connections between nodes in a local area of the page flow without the overlaps between lines and crossovers once the page flow grows complex in real applications. In addition, a declarative validation rule editor is operable to create and manage a plurality of declarative validation rules of the page flow and their associated messages at design time which can be used by the page flow runtime to keep the user from entering and/or submitting bad or invalid data into the page flow. This description is not intended to be a complete description of, or limit the scope of, the invention. Other features, aspects, and objects of the invention can be obtained from a review of the specification, the figures, and the claims.

### CLAIM OF PRIORITY

This application claims benefit from U.S. Provisional Patent Application No. 60/721,148, filed Sep. 27, 2005, entitled “Page Flow Editor” by Thomas A. Cook et al., (Attorney Docket No. BEAS-01835us0).

### CROSS-REFERENCE TO RELATED APPLICATIONS

This application is related to the following co-pending applications which are hereby incorporated by reference in their entirety:

U.S. patent application Ser. No. ______, entitled SYSTEM AND METHOD FOR PAGE FLOW EDITOR, by Thomas A. Cook, et al., filed: ______ (Attorney Docket No. BEAS-01835US1).

U.S. patent application Ser. No. ______, entitled METHOD FOR ACTION OUTPUT/PAGE INPUT MISMATCH DETECTION AND RESOLUTION, by Thomas A. Cook, et al., filed (Attorney Docket No. BEAS 1928US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to the field of page flow exploration and editing.

### BACKGROUND

A page flow is a collection, set or directory of Web application files that work together to implement a user interface (UI) feature. It allows a software developer to separate user interface code from navigational control and other business logic. User interface code can be placed where it belongs (e.g., in JSP files). Navigational control can be implemented easily in a page flow's single controller file, which is the nerve center of (a component of) a Web application. A page controller file is a special Java file that uses an annotation such as @Jpf.Controller. Business logic can be implemented in the page controller file, or in Java controls that are called from controller files. For a non-limiting example, a page flow could implement a Web application's user registration wizard feature. The files of such a page flow could be arranged in an exemplary “userRegistration” directory shown in FIG. 1, which contains several *.jsp files 101, a control file 102. The *jsp files are standard Java Server Pages (JSP) files that contain markup that describes the visual aspect of the user registration wizard. A Java control file contains annotated Java code that implements logic used by the user registration wizard. The *jpf file contains annotated Java code that implements the navigation and state management logic of the user registration wizard and that makes calls to business logic.

A page flow explorer provides a consistent means of locating and managing all artifacts (components, actions, or files) related to a given page flow via graphical and code-level tools to simplify the development cycle, whether editing the controller files or the member pages. The tree view of the explorer can be presented as a page flow graph (tree) that consolidates functions previously dispersed among the project tree, structure pane, data palette, property sheet, design palette, controls, and action view. The source view of the explorer presents syntax completion, validation, and other programmer's aids reduce the amount of work required to get your application running. Many artifacts are represented by nodes in the page flow graph. While the explorer view of the page flow is useful for doing basic management of the page flow related artifacts, it lacks features necessary to support complete editing of the page flow.

### BRIEF DESCRIPTION OF THE DRAWINGS

FIG. 1 shows an exemplary page flow implementing a Web application's user registration wizard feature as displayed in a page flow explorer.

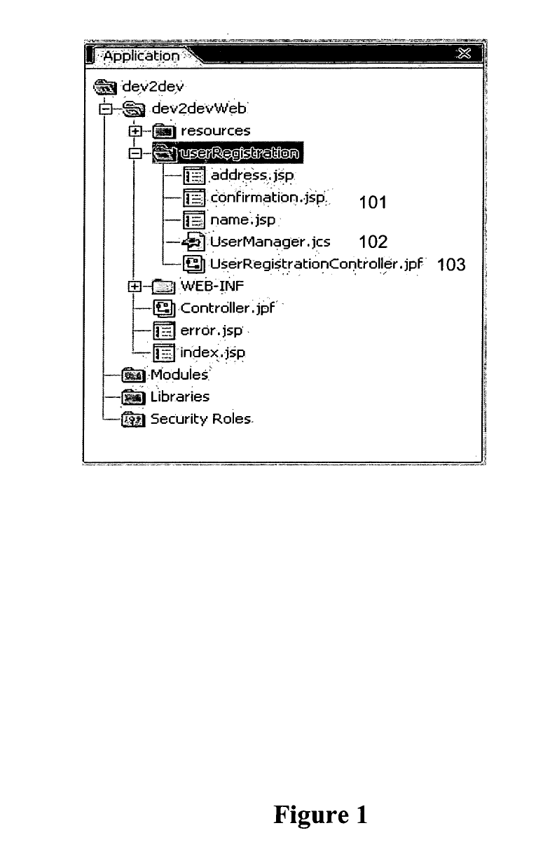

FIG. 2 is an illustration of an exemplary page flow editor in one embodiment of the present invention.

FIG. 3 is a flow chart illustrating an exemplary page flow editing process via in accordance with one embodiment of the invention.

FIG. 4 is an illustration of different types of links in a page flow editor in one embodiment of the present invention.

FIG. 5 (a)-(b) is an illustration of an exemplary flow path graph in one embodiment of the present invention.

FIG. 6 (a)-(b) is an illustration of exemplary validation rule editor in one embodiment of the present invention.

FIG. 7 is an illustration of exemplary detailed pane of the validation rule editor for displaying and editing properties of the selected node in one embodiment of the present invention.

FIG. 8 is an illustration of exemplary detailed pane of the validation rule editor for showing the parameters of a given rule and an associated error message in one embodiment of the present invention.

FIG. 9 is an illustration of exemplary validation message arguments dialog of the validation rule editor in one embodiment of the present invention.

FIG. 10 is an illustration of exemplary badge associated with an inherited property in one embodiment of the present invention.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

Various embodiments of the present invention enable a three-pane page flow editor optimized for viewing and editing a page flow. It centers around a selected focal node referenced in the page flow editor, shows details and allows editing in the vicinity of the node. It provides a visual representation of nodes and the connections among them, enabling the ability to read and edit connections between nodes in a local area of the page flow without the overlaps between lines and crossovers once the page flow grows complex in real applications. Consequently, user can edit a page flow via dragging and dropping of entities instead of switching back and forth between the two design views, or a design view and source view. Additionally, a declarative validation rule editor is operable to create and manage a plurality of declarative validation rules of the page flow and their associated messages to keep the user from entering and/or submitting bad or invalid data into the page flow.

Various embodiments of the present invention provides at least the following capabilities for the page flow editor:

A clear local picture of inputs and outputs for a given node, uncluttered by irrelevant nodes and links.

A canned, standardized layout where every link is easy to locate, select, and edit.

A place to put additional details, such as global forwards raised by an action, that would otherwise unduly clutter the main view.

A way to dynamically trace paths through the flow using in a sequential frame presentation, similar to time-based media editors.

A unified context for editing both JPF and JSP files.

A means of quickly navigating to various source artifacts that make up a page flow.

An integration with source view for a less disjointed overall editing experience.

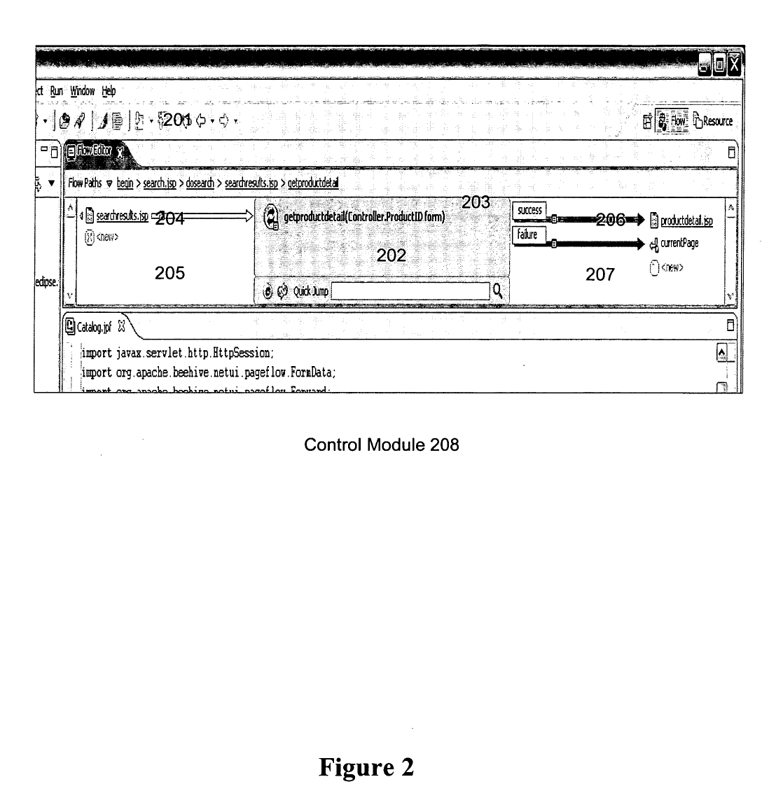

FIG. 2 is an illustration of an exemplary page flow editor in one embodiment of the present invention. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

Referring to FIG. 2, the central section (pane) 202 of the page flow editor 201 shows details of the current node 203 and navigation in the flow editor is based on bringing a given node into view in this central section. Initially, the current node is the begin action when editing a page flow (if it exists in the page flow, otherwise, it can be another local action). It is, in essence, the “home” node for a page flow, much like a “home” page on a Web site. The upstream 204 and downstream 206 connections (links, forwards) and nodes of the current node in the page flow are shown in the sections to the left 205 and right 207 of the center section, respectively. In addition, the left and right sections provide locations for creating additional links, reconnecting existing links, or deleting existing upstream links upstream or downstream. The entire page flow editor is supported by an independent underlying control module 208 behind this view, which provides navigational control and other business logic to support the page view on top of it.

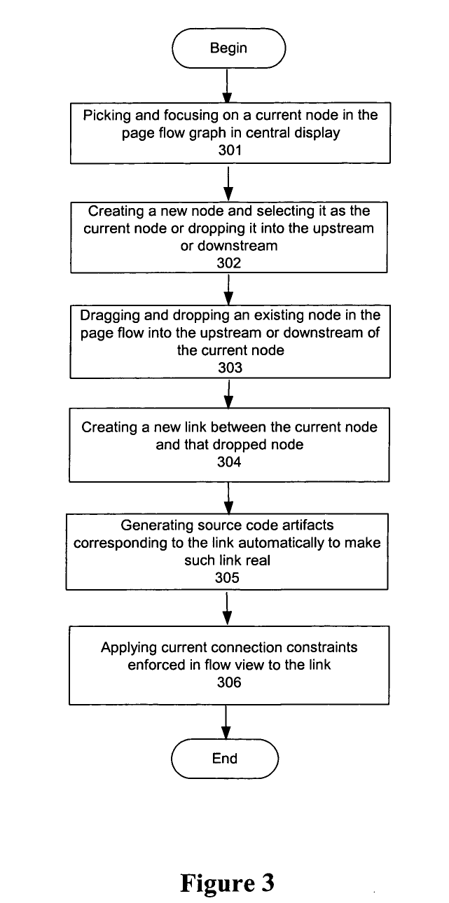

FIG. 3 is a flow chart illustrating an exemplary page flow editing process in accordance with one embodiment of the invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 3, a current node in the page flow graph is picked and focused on in central display at step 301. Optionally, a new node can be created before it is selected as the current node or dropped into the upstream or downstream section at step 302. An existing node in the page flow can be dragged and dropped into the upstream or downstream of the current node at step 303, and a new link can be created between the current node and that dropped node at step 304. Dragging the node into the downstream means the dropped node is the destination end of the link, while dragging the node into the upstream means the dropped node is on the source side of the link. Source code artifacts corresponding to the link are generated automatically to make such link real at step 305 and current connection constraints as enforced in flow view is applied to the link at step 306.

In some embodiments, nodes that are inherently terminal and can only have a single upstream reference, which include but are not limited to, return node, an unspecified node, can never be the focal node; they only appear in the downstream section. An exit node nodes can have multiple upstream nodes, but will never be the focal node. Nodes that are inherently terminal but support more than one upstream reference—such as a shared flow action, external page flow, or external page—are allowed as focal nodes since this is the only way to easily see all the nodes that refer to them.

In some embodiments, a user can move upstream or downstream in the page flow following path through the graph by clicking the link portion of an upstream or downstream node. The clicked node then becomes the new current node and is displayed in the central section. A user can also jump to other nodes in the page flow by specifying the name of the node to jump to, or dragging a node from the page flow tree and dropping it into the central section.

In some embodiments, a user can reattach a link via a context menu on the link itself, or by dragging and dropping of the new destination node onto the existing destination node. An existing link to the current node can also be deleted in the similar manner. The node in the upstream or downstream section, however, should be removed from view since it no longer has an association with the current node.

In some embodiments, the page flow editor supports the displaying of source code and/or the annotation metadata of the corresponding artifacts/actions (nodes), wherein the artifacts and the links to the nodes in the page flow view is automatically updated to be in sync with any change made in the source code.

In some embodiments, several artifacts can be registered with the page flow if they are dragged from the project tree, although most drags onto the page flow editor originate from the page flow. Such artifacts include but are not limited to, external pages, html files, plain text files, other existing page flows, controls, shared flow and message bundles.

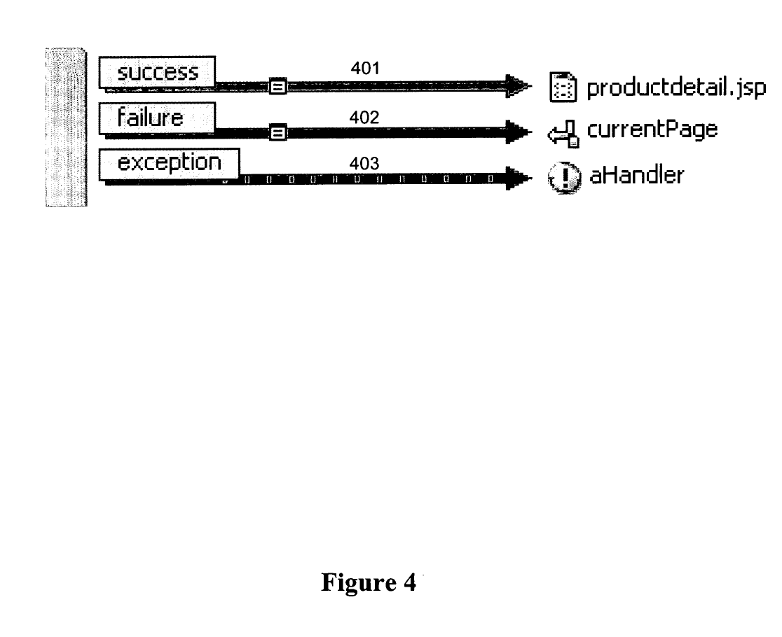

In some embodiments, the page flow editor makes distinction among different link types, showing different representations of forwards (success) 401, validation error forwards (failure) 402, and catches (exception forwards) 403 as shown in FIG. 4. The states of the links such rollover and selection states can be associated with the corresponding links.

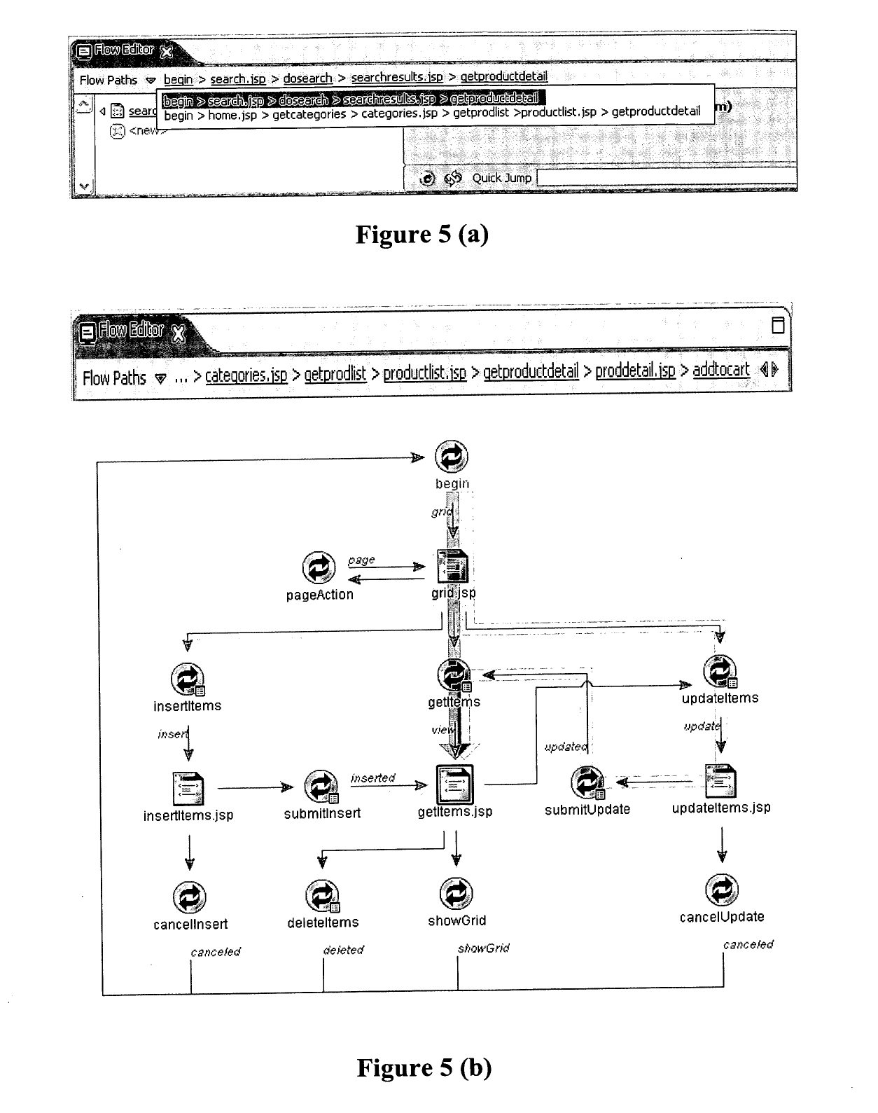

In some embodiments, the page flow editor also supports a flow path section of the editor, which displays the path(s) from the begin node in the page flow to provide additional context around the current node as shown in FIG. 5 (a)-(b). It also provides a quick means of navigating upstream by allowing the user to select which path to display. The selected path is then rendered as a set of links.

In some embodiments, the page flow editor also supports a plurality of node types as listed below:

Return Nodes. These nodes reflect the NavigateTo attribute on an annotation, providing for symbolic navigation.

Exit Nodes. These nodes reflect the returnAction attribute on an annotation in a nested page flow. It designates the action to be raised in a nesting page flow upon a particular completion path of the nested flow.

Mystery Nodes. These nodes reflect an empty path attribute on an annotation.

In some embodiments, the page flow editor supports refactoring across multiple programming languages and files. Once a node in the page flow is renamed, the underlying model of the page flow editor will fix references to the node across files and languages in the page flow so that every reference to the node is in sync. Such cross file and platform refactoring is performed transparent to the page flow display and the user.

Declarative Validation Rule Editor

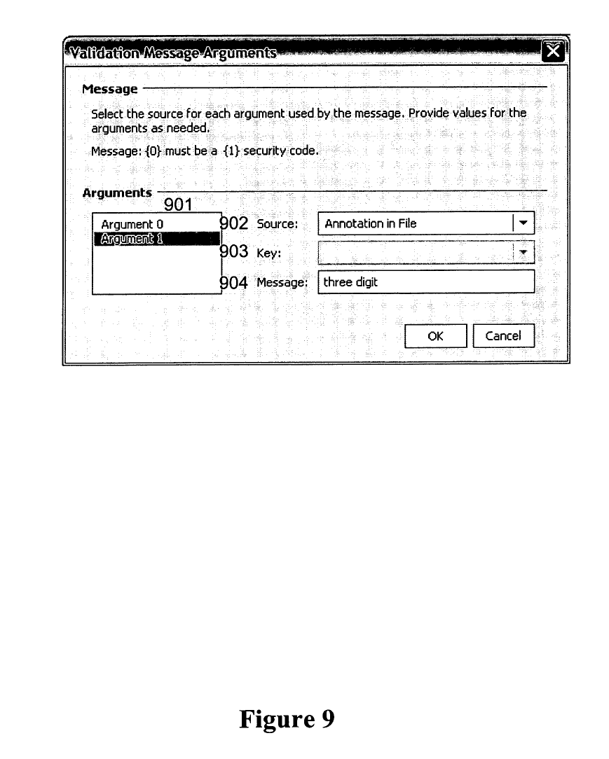

In some embodiments, a validation rule editor can be provided to facilitate creation and management of validation rules of the page flow and associated messages. FIG. 9 shows an exemplary validation rule editor in accordance with some embodiments of the present invention. The validation rule editor offers graphical way to create and edit declarative field validation rules through Java annotations, which extends the user input validating approach of defining a validate method in, for a non-limiting example, a custom form bean, that returns an indirect reference to an error message (in a resource file) for each bean property that is in error. In addition, the validation rule editor allows users to edit the rules/messages in an Integrated Design Environment (IDE). A major advantage offered by the validation rule editor is the necessary flexibility and power, while still allowing a very simple base case.

In some embodiments, when a user submits an HTML form on a web page, it posts the values in the form back to the Web server. In the page flow framework, page flow authors control what happens next by writing controller code in a page flow action. The page flow author then has the opportunity to access the form data by means of a Java object, which can be but is not limited to a form bean and is passed as a parameter to the page flow action. Once the code in the action method is executing, inspection of the form bean (and form data) is possible. In order to keep the user from entering bad or invalid data into the web page and submitting it, we help page flow authors create these validation rules. If the user then puts bad data in the web form, the page flow runtime framework can then trigger different behavior, perhaps showing the form to the user again and asking them to correct mistakes. This editor helps author those validation rules and save them as metadata that the page flow runtime framework can use. Here, page flow runtime framework is an annotation-driven web application programming framework that centralizes navigation logic, state, metadata, and exception handling in a single encapsulated and reusable page flow controller class. It also provides a set of JSP tags for rendering HTML/XHTML and higher-level UI constructs such as data grids and trees.

In some embodiments, the validation rule editor can be launched from any of the following locations where the validation annotations can occur:

Any action that uses a form bean can also have validation rules associated with the action. A menu item can be added to the context menu for an action to launch the editor.

Form beans that reside on the page flow editor will provide another launch point for the rule editor. As with actions, a validation rule may be added to either the page flow, or the form bean itself, depending on which context menu item is clicked.

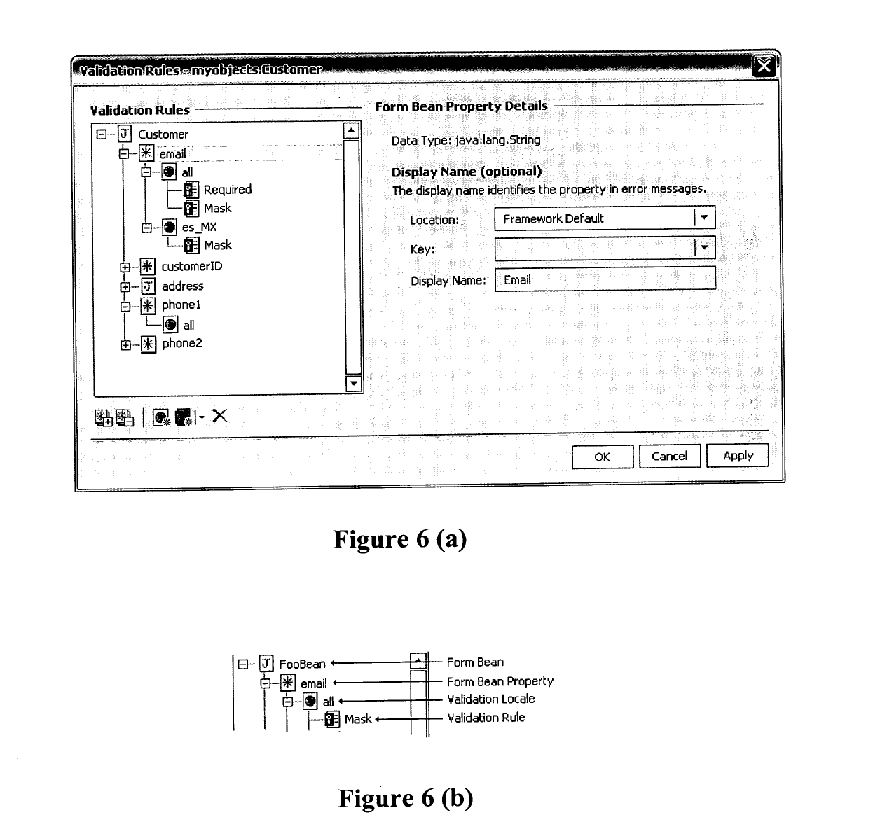

In some embodiments, the rule editor operates with relation to a particular bean type, which properties are displayed in a tree pane. Validation rules can be defined relative to a given property and reside in validation locales. Each property may have one or more validation locales, each of which may in turn have one or more validation rules. The validation rules pane reflects this hierarchy, with each level represented by a different icon, as shown by 601 in FIG. 6 (a), and summarized in FIG. 6 (b). Since each form bean property requires a validation locale node as a container for rules, there will be one such node provided under each bean property with a default setting of all. This setting may be changed to “nonspecific” or a specific locale. Additional validation locale nodes can be added under the same property. Furthermore, each node type has a context menu for managing child nodes and related functions. Editing properties of the selected node, where applicable, takes place in the pane on the right side of the editor.

In some embodiments, a new validation locale menu item can be selected from form bean property context menu to create a new container node for validation rules. The default setting for the validation locale will depend on setting for sibling containers under the same parent, to avoid duplication, and progress from the general to the specific, i.e., the locale is set to All unless a locale with that setting already exists. If All exists, the locale should be set to Default, unless it already exists. If both All and Default already exist, a specific locale is opted. Specific locales have no language or country codes initially, but appear in the tree as “unspecified locale”. These nodes are in error until a language code is provided.

In some embodiments, a rule from a new rule cascade menu can be chosen from form bean property context menu to create a validation rule node under the selected validation locale, and selects the new node. Rules that already exist under the selected validation locale should have their corresponding menu item disabled except for the Custom rule, which can have multiples. The rule name should be appended, once it has been given, to the rule type to tell the rules apart in the tree. For a non-limiting example, a custom rule named foo would appear in the tree as “Custom: foo”. Deleting a validation locale node from the tree deletes both the node and all contained rules. A confirmation prompt should be thrown asking the user to confirm deletion of the validation locale and the contained rules.

In some embodiments, using a tree pane to present the rules facilitates duplication and re-categorization of rules and validation locales by moving and copying nodes in a drag and drop fashion. To make validation locales and rules draggable, nodes must always occupy their same level in the tree, so validation locale nodes can only be dropped onto properties and rule nodes can only be dropped onto validation locales.

In some embodiments, Cut, Copy, and Paste items can be added to the context menus of validation locale and rule nodes as well, which is a better way supporting the scenarios were one would like to have a particular rule, like Required, on a lot of different properties. The rule could be created under one property, then copied and quickly pasted into the remaining required properties.

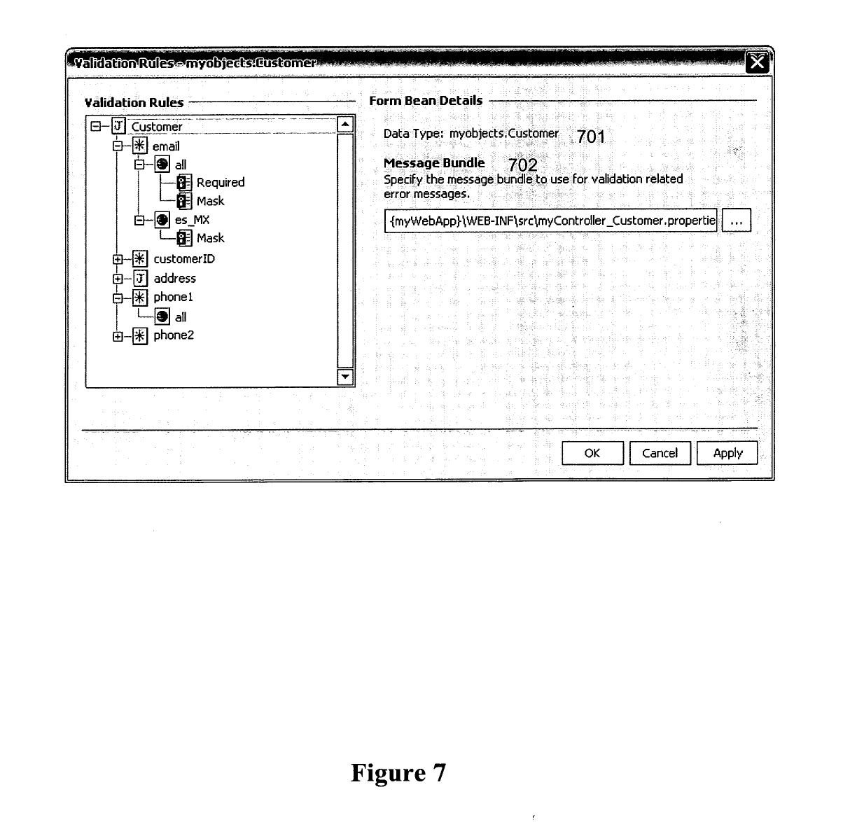

In some embodiments, each of the node types in the tree will have a details pane on the right-hand side of the editor to display and edit properties of the selected node as shown in FIG. 7. The Data Type field 701 shows the fully qualified class name of the bean. The Message Bundle 702 shows the message bundle to be associated with the bean. If the Message Bundle points to a file that cannot be found the form bean node should be red squiggled (a method used to indicate an error) until such point as a valid bundle is specified or all references to a message bundle are removed from the rules. The same is true if no message bundle is specified under these circumstances. For rules written on the form bean itself, the field is initially blank.

In some embodiments, the message bundle field may also have a value that is inherited, whether as a page flow default message bundle or a form bean message bundle. In that case the field would use the “inherited” message bundle by default, but this can be overridden. In this case, an indication is shown that the bundle declaration has been inherited. If users attempt to edit or create a new message and no message bundle has been set, an information message dialog can be thrown with the following message: “No message bundle has been specified. You must specify a message bundle to use for validation messages. Specify message bundle now? [Yes][No]”.

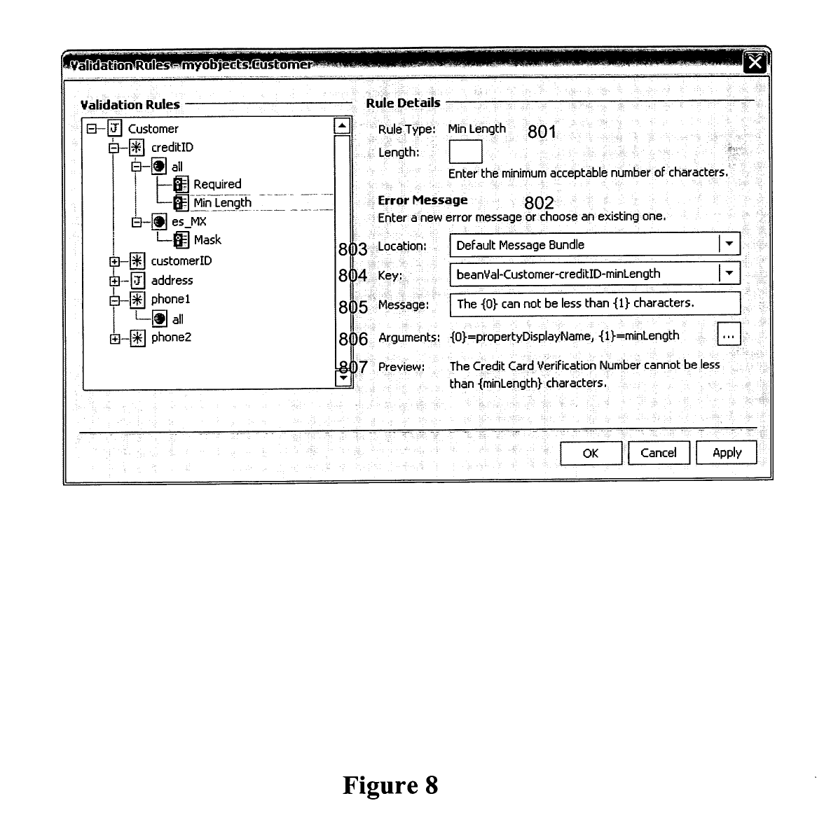

In some embodiments, a validation rule details pane shows the parameters of a given rule and an associated error message as illustrated in FIG. 8. The Rule Type field 1101 determines which fields appear below for defining the parameters of the rule, which is read-only since the type was selected at the time the rule was created and is immutable thereafter. Users should be able to associate error messages 802 with validation rules at the same time they are authoring the rules. While users need support to associate existing messages with rules, it will probably also be very common to write new messages when creating new rules. The Location field 803 contains three values: “Framework Default”, “Annotation in this File”, and “Default Message Bundle”. The first is the default setting. Under the Location field “Annotation . . . ” option, the value of the Message field is persisted in the message attribute of the validation rule annotation. Under the Location field “. . . Message Bundle” option, both Key and Message fields must have a value if either of them does. The value of Message is persisted in the default message bundle with a message key corresponding to the value of the Key field, and a reference to the entry is made in the messageKey attribute on the corresponding validation rule annotation. The Key field 804 is a combo box that contains a list of all the keys in the default bundle. Selecting a key from the list displays the associated message in the Message field and any edits made to the message are persisted. A default value in the key field assumes a new key is being created and the default name is a concatenation of a prefix indicating that this is a form bean validation message followed by the class name, followed by the property name, followed by the rule type. The Message field 805 shows the message corresponding to the key selected in the Key field, or is initially blank if a new key is being created, or the message is being place directly in the rule annotation. For messages that go into a message bundle, a value must be provided for both Key and Message fields if a value is provided for either, otherwise the corresponding rule node in the tree is red squiggled. If both fields already have values, and are subsequently cleared, the messageKey attribute is removed from the corresponding property-level annotation, but leave the message bundle unchanged. The Arguments field 806 shows the default framework provided arguments, Its format is “{0}=[argname]’, where argname is a label that we give to each of the framework provided arguments. The label is for display purposes only, but allows us to show something reasonable before the rule parameters are supplied. (The Preview field will show the actual values of the parameters). The Preview field 807 attempts at rendering the message as it will appear at runtime. For any arguments that can't resolve at design time we'll just show a substitution of the argument token—i.e., {1}—with the closest approximation we can come up with. For framework provided defaults, before the rule has been parameterized, we'll use the argument name. So, rather than “The {0} field . . . ” we'd display “The {propertyDisplayName}field . . . ”. If the argument is an expression that can't be resolved, we'll show the expression in place of the argument token.

In some embodiments, a validation message arguments dialog shown in FIG. 9 can be used for editing the arguments. The arguments listbox 901 is populated with one entry for each argument in the Message field on the Rule Details pane in the editor. Selecting one of the of the listbox entries populates the fields at the right, where the first argument should be selected initially when the dialog is launched. The values in the Source dropdown list 902 at the left can be but are not limited to: “Framework Default”, “Page Flow Default Message Bundle”, and “Annotation in File”. The initial setting is “Framework Default”. Choosing “Framework Default” shows a read-only version of the argname in the Message field. For a given rule, arguments unused by the framework should display <none>. Choosing “Page Flow Default Message Bundle” enables the Key field 903, which is populated with keys from the from the page flow's default bundle. Selecting a key display the corresponding message in the Message field 904. Both the key and message fields are editable and require the same validation as their counterparts on the Rule Details pane. The key is persisted in the corresponding argKey attribute on the rule annotation. Choosing “Annotation in File” enables the Message field (and disables the Key field). The contents of the entry field are persisted on the corresponding argument attribute on the rule annotation.

In some embodiments, properties that are inherited may have rules written against them in the base class. These rules are in effect for any subclasses unless overridden. The editor must deal appropriately with inherited properties in each of the rules scopes, as detailed below.

Page Flow Scope: since this annotation effectively overrides any rules written in the form bean—whether inherited or not—inherited properties don't have to be treated any differently than non-inherited properties.

Action Scope: here, inherited properties don't need to be treated any differently than non-inherited properties for this context.

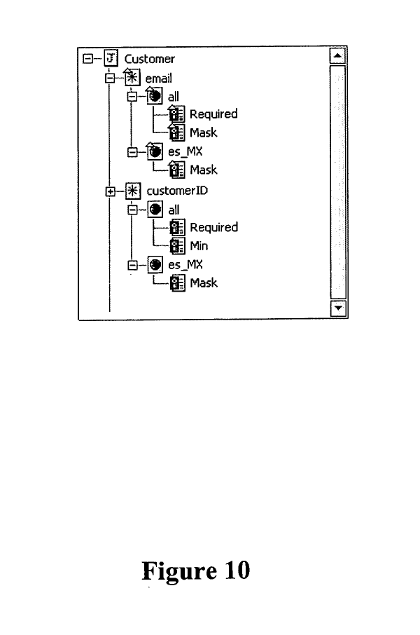

Form Bean Scope: here the inherited properties should be displayed with an associated badge on the corresponding icon and any validation locales and rules residing in the base class should also be displayed with the same badges as shown in FIG. 10. The details panes for property, validation locales, and rules should all be read-only, since the corresponding annotations reside in a different file. Further, since there is no context in the subclass on which to place overriding annotations, there should be no context menus on any of those nodes. When one of the inherited nodes is selected, an informational message should displayed in the message area stating that “Inherited validation annotations cannot be modified from a subclass.”

In some embodiments, page flow scoped rules can be inherited in a controller subclass. No editing of these rules can be allowed from the subclass, but users are allowed to view them using the rule editor. Users can also override the entire set of inherited rules displayed in the rule editor. To this end, the rule editor needs to be changed at least in the following ways:

All validation locale and rule nodes in the tree have the “inherited badge”.

No edit can be performed via any details pane for any node in the tree.

The context menu for any node in the tree has only a single item—“Override Inherited Rules”.

Choosing the Override Inherited Rules context menu item should pop the following confirmation dialog: “All currently displayed rules will no longer apply in this context. Do you want to override anyway?” [Yes][No]

Clicking the Yes button resets the tree—and the editor as a whole—to the state it would be in when creating page flow scoped rules for a particular bean the first time. Clicking the No button cancels the operation, making no changes.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “module” is used in the embodiments of the systems and methods described above, it will be evident that such concept can be interchangeably used with equivalent concepts such as, class, method, type, interface, bean, component, object model, and other suitable concepts while the concept “artifact/action” is used in the embodiments of the systems and methods described above, it will be evident that such concept can be interchangeably used with equivalent concepts such as, class, method, type, interface, bean, component, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to support declarative validation rule for page flow editing, comprising:
a page flow comprising of a plurality of nodes and links among the nodes,
wherein the page flow represents a set of Web application files used to implement a user interface;
a page flow editor operable to display and edit the page flow;
a control module operable to support displaying, navigating, and editing of the page view via the page flow editor; and
a declarative validation rule editor operable to create and manage a plurality of declarative validation rules of the page flow and their associated messages to keep a user from entering and/or submitting bad or invalid data into the page flow.

2. The system according to claim 1, wherein:
each of the Web application files is a Java file.

3. The system according to claim 1, wherein:
each of the plurality of nodes is one of: an external page, a html file, a plain text file, another existing page flow, a control, a shared flow, and a message bundle.

4. The system according to claim 1, wherein:
the page flow editor is operable to support at least one of:
an overview of the page flow being edited; and
generating and displaying routes of links between nodes in the overview of the page flow.

5. The system according to claim 1, wherein:
one of the plurality of validation rules is inherited, which only to be viewed but not edited.

6. The system according to claim 1, wherein:
one of the plurality of validation rules is defined relative to a property and resides in one or more validation locales.

7. The system according to claim 6, wherein:
the property is inherited and overrides the validation rule.

8. The system according to claim 6, wherein:
the declarative validation rule editor is operable to duplicate and re-categorize the plurality of validation rules and/or the one or more validation locales by copying and moving nodes in the pane in a drag and drop fashion.

9. The system according to claim 1, wherein:
the declarative validation rule editor is launched from an action and/or a bean in the page flow.

10. The system according to claim 1, wherein:
the declarative validation rule editor is operable to display and edit the plurality of validation rules in a tree structure.

11. The system according to claim 1, wherein:
the declarative validation rule editor is operable to present one of the plurality of validation rules and/or its associated error message.

12. The system according to claim 1, wherein:
the declarative validation rule editor is operable to display and edit one or more argument of the plurality of validation rules.

13. The system according to claim 1, wherein:
the declarative validation rule editor is operable to save the plurality of validation rules as metadata that the page flow runtime can use and enforce.

14. A method to support declarative validation rule for page flow editing, comprising:
representing a page flow via a plurality of nodes and links among them,
wherein each of the plurality of nodes represents an action in the page flow that is used to implement a user interface;
displaying, navigating, and editing the page flow via a page flow editor; and
creating and managing a plurality of declarative validation rules of the page flow and their associated messages to keep a user from entering and/or submitting bad or invalid data into the page flow.

15. The method according to claim 14, further comprising:
supporting an overview of the page flow being edited.

16. The method according to claim 14, further comprising:
generating and displaying routes of links between nodes in the overview of the page flow.

17. The method according to claim 14, further comprising at least one of:
defining one of the plurality of validation rules relative to a property,
which resides in one or more validation locales;
overriding the validation rule if the property is inherited;
duplicating and re-categorizing the plurality of validation rules and/or the one or more validation locales by copying and moving nodes in the pane in a drag and drop fashion; and
presenting one of the plurality of validation rules and/or its associated error message.

18. The method according to claim 14, further comprising:
displaying and editing one or more of:
the plurality of validation rules in a tree structure; and
one or more argument of the plurality of validation rules.

19. A machine readable medium having instructions stored thereon that when executed cause a system to:
represent a page flow via a plurality of nodes and links among them,
wherein each of the plurality of nodes represents an action in the page flow that is used to implement a user interface;
display, navigate, and edit the page flow via a page flow editor; and
create and manage a plurality of declarative validation rules of the page flow and their associated messages to keep a user from entering and/or submitting bad or invalid data into the page flow.

20. A system to support declarative validation rule for page flow editing, comprising:
means for representing a page flow via a plurality of nodes and links among them, wherein each of the plurality of nodes represents an action in the page flow that is used to implement a user interface;
means for displaying, navigating, and editing the page flow via a page flow editor; and
means for creating and managing a plurality of declarative validation rules of the page flow and their associated messages to keep a user from entering and/or submitting bad or invalid data into the page flow.
